(19) United States
(12) Patent Application Publication
(10) Pub. No.: US 2013/0174051 A1
(43) Pub. Date: Jul. 4, 2013

(54) BUNDLING CONTENT AND FUNCTIONALITY INTO DATA THAT IS REFERENCED BY A TAG

(71) Applicants: Richard SCHATZBERGER, New York, NY (US); Michael LEBOWITZ, Brooklyn, NY (US)

(72) Inventors: Richard SCHATZBERGER, New York, NY (US); Michael LEBOWITZ, Brooklyn, NY (US)

(73) Assignees: Big Spaceship LLC, Brooklyn, NY (US); Co Collective LLC, New York, NY (US)

(21) Appl. No.: 13/729,238

(22) Filed: Dec. 28, 2012

Related U.S. Application Data
(60) Provisional application No. 61/581,330, filed on Dec. 29, 2011.

(51) Int. Cl. G06F 3/0484; G06F 3/048

(52) U.S. Cl. CPC G06F 3/04842
USPC 715/748

(57) ABSTRACT

There is provided a method that includes (a) receiving digital content, (b) providing, via a first user interface, a template that lists a plurality functions, (c) receiving a communication that indicates an enabled function from the plurality of functions, (d) storing the digital content and the enabled function, as data in a database, (e) transmitting a link to access the data in the database, and (f) generating a second user interface to display the digital content and perform the enabled function.

### BACKGROUND OF THE INVENTION

1. Field of the Invention

The present disclosure relates to a use of a tag, for example a quick response (QR) tag, and more particularly, to a bundling of content and functionality into data that is referenced by such a tag.

2. Description of the Related Art

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

When a user consumes a certain piece of content in a printed medium (e.g., a magazine, a film, a newspaper, or a package for a product) or on an object, (e.g., an article of clothing or an automobile), there is no actionable object that allows the user to mobilize, share and save the content for further use after consumption. Likewise, there is no mechanism for a publisher to generate functionality in a dynamic, rapid and manageable fashion.

Publishers have created digital versions of print content, but users must discover this content separately from the printed content. In some cases, publishers provide uniform resource locators (URLs) to Internet websites at which users can access additional content, but to access the websites, the user must manually enter the URL in a device such as a computer.

The creation of tags (e.g., quick response (QR) tags) that lead to content are based around one-off custom content creation making this a very manual labor intensive process. There is a need for a system that manages the content and the relation between the tag and the content.

### SUMMARY OF THE INVENTION

There is provided a method that includes (a) receiving digital content; (b) providing an interface that includes a template through which a user may enable a function from a plurality functions; (c) receiving a communication that indicates an enabled function from said plurality of functions; (d) storing said digital content and said enabled function, as data in a database; and (e) transmitting a link to said data.

There is also provided a method that includes (a) receiving a request for data, wherein said data includes digital content and a function; (b) transmitting said data; (c) receiving a request to execute said function; and (d) executing said function.

There is also provided a method that includes (a) in an exchange of electronic communications with a computer (i) receiving digital content; (ii) providing an interface that includes a template through which a first user may enable a function from a plurality functions; (iii) receiving a communication that indicates an enabled function from said plurality of functions; (iv) storing said digital content and said enabled function, as data in a database; and (v) transmitting a link to said data, wherein said link is associated with a tag; and (b) in an exchange of communications with a device that has captured said tag (i) receiving said link; (ii) retrieving said digital content and said enabled function from said database; (iii) transmitting said digital content; (iv) providing an interface for a second user to select said enabled function; (v) receiving a request to execute said enabled function; and (vi) executing said enabled function.

There is also provided a system that performs the method, and a storage medium that contains instructions for controlling a processor to perform the methods.

### BRIEF DESCRIPTION OF THE DRAWINGS

FIG. 1 is a block diagram of a system for bundling content and functionality into data that is referenced by a tag.

FIG. 2 is a flowchart of a method for bundling content and functionality into data that is referenced by a tag.

FIG. 3 is a flowchart of a method for utilizing data that includes content and functionality and that is referenced by a tag.

FIG. 4 is a block diagram of an embodiment of a content management system that is a component of the system of FIG. 1.

A component or a feature that is common to more than one drawing is indicated with the same reference number in each of the drawings.

### DESCRIPTION OF THE INVENTION

There is described herein a system for bundling content and functionality into data that is referenced by a tag. The system allows an administrator to provide content, and define functionality associated with the content. The system stores the content and data representing the functionality, and generates a data reference link, e.g., a URL, to the stored content and functionality data. The URL is either embedded in, or associated with, a tag, e.g., a QR code, that is in turn associated with an object or a place. A user of a device such a mobile phone captures the tag, and the device is linked to a website that provides the content and the functionality. For example, the tag can be a QR code on a magazine article about an automobile, where the user, after scanning the QR code, is presented with a web page that provides (a) information about the automobile, and (b) functions for sharing or saving the information.

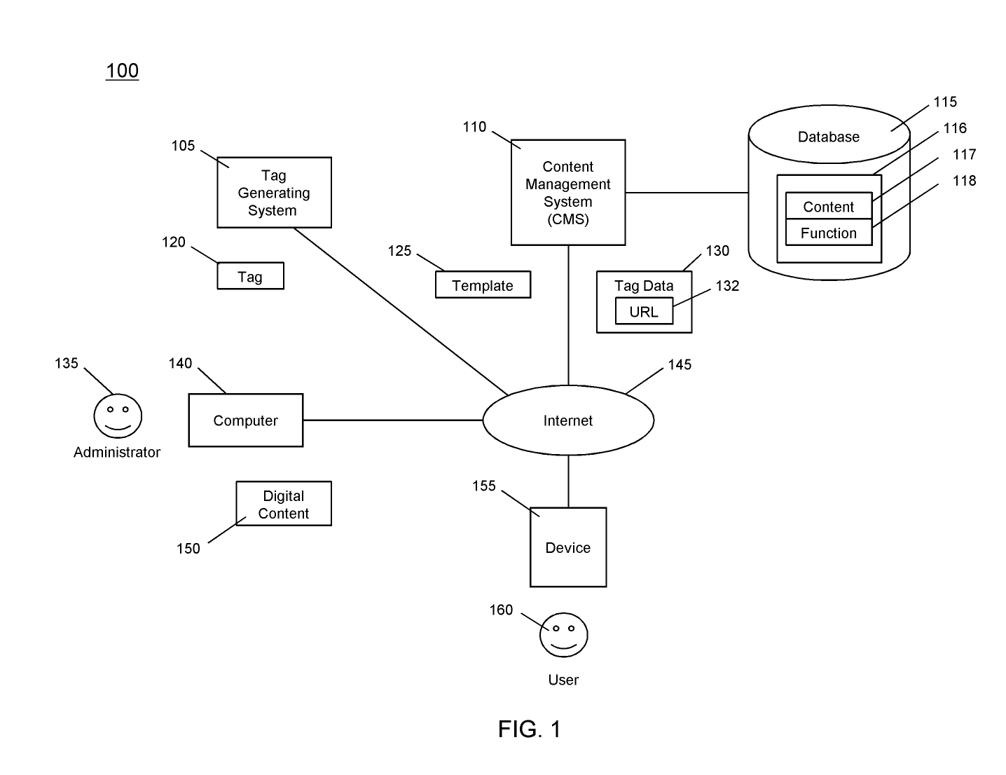

FIG. 1 is a block diagram of a system 100 for bundling content and functionality into data that is referenced by a tag. System 100 includes a tag generating system 105, a content management system (CMS) 110 and a database 115, each of which is communicatively coupled to the Internet 145, i.e., a data communication network. A computer 140 and a device 155, e.g., a mobile telephone, are also communicatively coupled to the Internet 145. An administrator 135 operates computer 140, and a user 160 operates device 155.

Communications conducted over the Internet 145 are done so by way of electronic communications, for example, utilizing a protocol such as Transmission Control Protocol/Internet Protocol (TCP/IP).

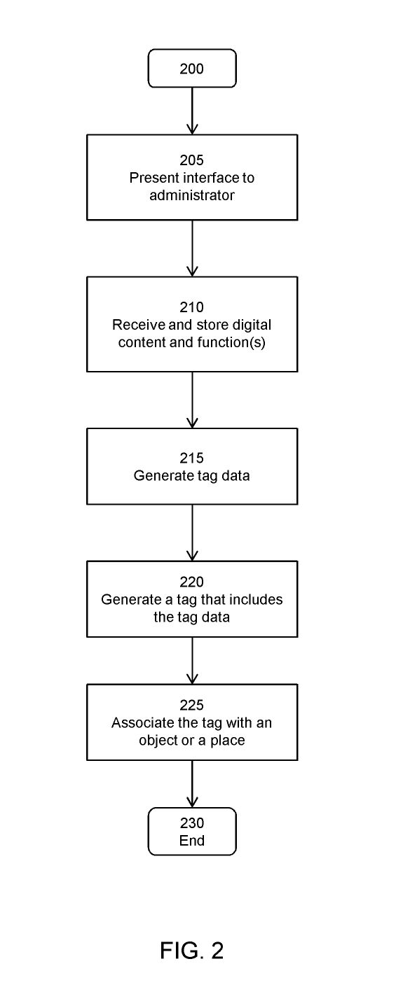

FIG. 2 is a flowchart of a method 200 for bundling content and functionality into data that is referenced by a tag. Method 200 commences with step 205.

In step 205, administrator 135 by way of computer 140, accesses CMS 110, which, in turn, presents an administration interface on computer 140. From step 205, method 200 progresses to step 210.

In step 210, administrator 135, through utilization of the administration interface, uploads digital content 150 to CMS 110. Digital content 150 can include text, images, audio, video and combinations thereof. CMS 110 receives digital content 150 and stores it into database 115 as content 117.

Via the administration interface, CMS 110 also presents a template 125 that lists one or more functions that can be enabled by administrator 135 and attributed to content 117. Although any function can be defined, exemplary functions include SHARE, SAVE, PURCHASE, VIEW and ENGAGE.

The SHARE function allows user 160 to share content 117 with an application, for example, a social network application, an email application, a short message service (SMS) application, and instant messaging (IM) application, or a blog.

The SAVE function allows user 160 to save content 117.

The PURCHASE function allows user 160 to purchase something described in content 117.

The VIEW function allows user 160 to view content 117 and/or additional content. This function may include text-to-audio conversion, and language translation.

The ENGAGE function allows user 160 to correspond with a website about content 117. For example, user 160 may wish to comment about content 117, rate content 117, rate a product or service being described in content 117, or request more information about a product or service being described in content 117.

Administrator 135 selects, and thus enables, one or more functions from template 125, and provides additional information for the performance of the functions. For example, as mentioned above, the SHARE function will allow user 160 to share content 117 with an application. As such, CMS 110 prompts administrator 135 for information that defines the applications, e.g., a particular social networking application, with which content 117 can be shared. This allows administrator 135 to manage copyright issues.

CMS 110 stores data relating to the selected function(s) into database 115 as function(s) 118. Content 117 and function(s) 118 are collectively referred to herein as data 116.

From step 210, method 200 progresses to step 215.

In step 215, CMS 110 generates tag data 130 that contains a URL 132, i.e., a data reference link, to data 116. CMS 110 sends tag data 130 to tag generating system 105. From step 215, method 200 progresses to step 220.

In step 220, tag generating system 105 generates a tag 120 that includes tag data 130. Tag 120 can be in any desirable form, but exemplary forms include bar codes, quick response (QR) codes, and radio frequency identification (RFID). Tag 120 can also be an image of a thing, e.g., an image of a cover of a book, or a geolocation marker, e.g., a latitude and a longitude. The uses of these various tags are described below. From step 220, method 200 progresses to step 225.

In step 225, tag 120 is associated with an object or a place. This activity can be performed manually by administrator 135, or some other party (not shown), or automatically by tag generating system 105 or another component (not shown).

For example, assume that tag 120 is being associated with a printed article such as a poster. Tag 120 can be in the form of a QR code that is printed on the poster, where tag data 130 is embedded in the QR code.

For example, assume that tag 120 is being associated with an object such as a woman's blouse. Tag 120 can be in the form of an RFID tag that is embedded within the woman's blouse, where tag data 130 is embedded in the RFID tag.

For example, assume that tag 120 is being associated with an object that can be recognized by way of an image recognition process, such as a front cover of a book. Tag 120 can be an image of the object, i.e., an image of the front cover of the book, where the image and tag data 130 are represented together in a data structure, and where the data structure is stored in an image recognition server (not shown).

For example, assume that tag 120 is being associated with a place. Tag 120 can be a geolocation marker of the place, where the geolocation marker and tag data 130 are represented together in a data structure, and where the data structure is stored in a geolocation recognition server (not shown).

From step 225, method 200 progresses to step 230.

In step 230, method 200 ends.

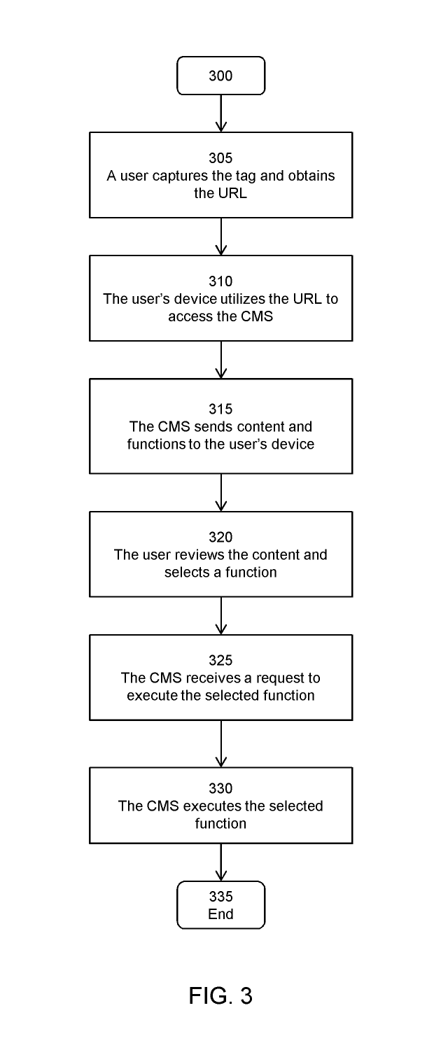

FIG. 3 is a flowchart of a method 300 for utilizing data that includes content and functionality and that is referenced by a tag. Method 300 commences with step 305.

In step 305, user 160, when in the vicinity of an object or place associated with tag 120, utilizes device 155 to capture tag 120, and ultimately obtain URL 132. Any suitable technology can be employed by device 155 to capture tag 120, depending on the form of tag 120, but exemplary technologies include scanning and near filed communication (NFC).

For example, assume that tag 120 is in the form of a QR code. Accordingly, device 155 scans tag 120 and employs a QR code reading application that resides in device 155 to decode the QR code to obtain URL 132. As an alternative to employing a QR code reading application that resides in device 155, device 155 may capture an image of the QR code, and send the image, via the Internet 145, to a QR code reading application that resides on a CMS 110 or another server (not shown), to decode the QR code, obtain URL 132, and return URL 132 to device 155.

For example, assume that tag 120 is in the form of an RFID. Accordingly, device 155 employs an NFC application to read and decode tag 120 to obtain URL 132.

For example, assume that tag 120 is in the form of an image of an objection, where the image and tag data 130 are stored as part of a data structure in an image recognition server (not shown). Accordingly, device 155 takes a picture of the object, for example, by utilizing a camera feature of device 155, and sends the picture, via the Internet 145, to the image recognition server. The image recognition server matches the picture to the stored image, obtains URL 132 from the data structure, and returns URL 132 to device 155.

For example, assume that tag 120 is in the form of a geolocation marker, where the geolocation marker and tag data 130 are stored as part of a data structure in a geolocation recognition server (not shown). Accordingly, device 155 obtains a present location of device 155, for example, by utilizing a global positioning satellite (GPS) feature of device 155, and sends data representing the present location to the geolocation recognition server. The geolocation recognition server matches the data representing the present location to the stored geolocation marker, obtains URL 132 from the data structure, and returns URL 132 to device 155.

From step 305, method 300 progresses to step 310.

In step 310, device 155 utilizes URL 132 to access CMS 110, and requests data 116, and more particularly content 117 and functions(s) 118. From step 310, method 300 progresses to step 315.

In step 315, CMS 110 receives the request, and obtains data 116 from database 115, and sends data 116 to device 155. CMS 110 also sends rendering instructions to device 155, not merely hyper text markup language (HTML). CMS 110 returns content 117 and function(s) 118 in a form that is appropriate for the device that requested it, and also provides instructions on how to display content 117 and function(s) 118 and create an interface on device 155. This could come in the form of HTML and cascading style sheets (CSS), which would be rendered as a web page, or as a set of instructions to a native application on where to place the items inside a native interface. From step 315, method 300 progresses to step 320.

In step 320, via device 155, user 160 reviews content 117, and selects a function from among function(s) 118. From step 320, method 300 progresses to step 325.

In step 325, by way of a communication from device 155, CMS 110 receives a request to execute the selected function(s) 118. From step 325, method 300 progresses to step 330.

In step 330, CMS 110 executes the selected function(s) 118. As an alternative to CMS 110 executing the selected function(s) 118, CMS 110 could send to device 155 an instructional code for device 155 to execute the selected function(s) 118. Below, the functions SHARE, SAVE, PURCHASE, VIEW and ENGAGE are described in greater detail.

SHARE

CMS 110 generates a web service that allows a recipient of content, i.e., a recipient with whom the content is being shared, to view the same content as is being viewed by user 160, but formatted appropriately for the device on which the recipient is viewing the content.

For example, assume that function(s) 118 includes, and that user 160 selects, SHARE. Accordingly, device 155 sends to CMS 110 a communication indicating that user 160 wishes to share content 117 with an application. As mentioned above, examples of such an application include a social network application, an email application, a short message service (SMS) application, and instant messaging (IM) application, or a blog. When the sharing function is attached to content 117, user 160 will have the ability to share (a) the whole piece of content 117, or (b) a reference link to content 117. The sharing function will be performed using methods provided by each destination sharing platform or system. These can include but are not limited to; passing information to a separate application, e.g., an email application, on device 155, or using an application program interface (API) application protocol interface to pass content 117 or reference to that service in the cloud, e.g., a social networking site.

SAVE

User 160 saves a version of content 117 for future viewing. User 160 can return at any later time to view history of the saved content and perform any available function(s) 118.

For example, assume that function(s) 118 includes, and that user 160 selects, SAVE. Accordingly, device 155 sends to CMS 110 a communication indicating that user 160 wishes to save content 117. Content 117 can be saved to (a) device 155, (b) a storage area in CMS 110, or (c) a cloud storage service (not shown). The saving can be done by either saving a copy of content 117, or saving a reference, e.g., URL 132, to content 117.

PURCHASE

User 160 can purchase an object referenced in content 117 by clicking on a link to the object and being redirected to a location where the object is available for sale.

For example, assume that function(s) 118 includes, and that user 160 selects, PURCHASE. Accordingly, device 155 sends to CMS 110 a communication indicating that user 160 wishes to purchase something described in content 117. CMS 110 returns to device 155 a link to a website (not shown) through which user 160 can make the purchase.

VIEW

User 160 views content 117 and/or additional content, and can also access supporting content.

For example, assume that function(s) 118 includes, and that user 160 selects, VIEW. Accordingly, device 155 sends to CMS 110 a communication indicating that user 160 wishes to view content 117 and/or additional content. CMS 110 sends to device 155 either (a) content 117 and/or the additional content, or (b) a link to content 117 and/or the additional content. Content 117 and the additional content can be in any format, including text, images, audio, video and combinations thereof, and as noted above, this function may include text-to-audio conversion, and language translation.

ENGAGE

User 160 clicks through advertising related to content 117.

For example, assume that function(s) 118 includes, and that user 160 selects, ENGAGE. Accordingly, device 155 sends to CMS 110 a communication indicating that user 160 wishes to correspond with a website about content 117. For example, as mentioned above, user 160 may wish to comment about content 117, rate content 117, rate a product or service being described in content 117, or request more information about a product or service being described in content 117. CMS 110 either (a) provides a user interface via device 155, or (b) sends to device 155 a link to a website that provides a user interface, through which user 155 can correspond.

From step 330, method 300 progresses to step 335.

In step 335, method 300 ends.

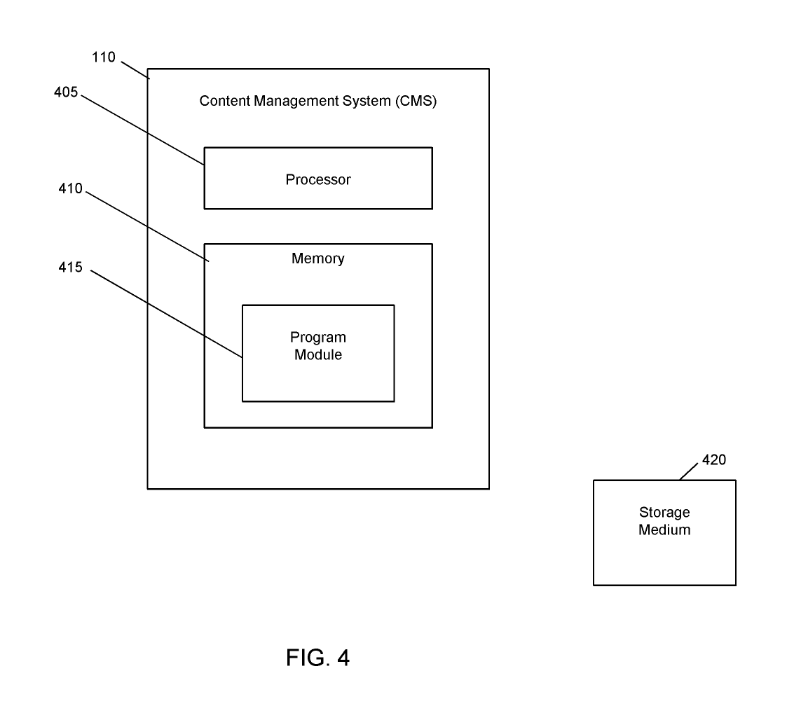

FIG. 4 is a block diagram of an embodiment of CMS 110. CMS 110 is implemented on a computer, e.g., a server, that includes a processor 405 and a memory 410. Although CMS 110 is represented herein as a standalone device, it is not limited to such, but instead can be coupled to other devices (not shown) in a distributed processing system.

Processor 405 is an electronic device configured of logic circuitry that responds to and executes instructions.

Memory 410 is a tangible computer-readable storage medium encoded with a computer program. In this regard, memory 410 stores data and instructions that are readable and executable by processor 405 for controlling the operation of processor 405. Memory 410 may be implemented in a random access memory (RAM), a hard drive, a read only memory (ROM), or a combination thereof. One of the components of memory 410 is a program module 415.

Program module 415 contains instructions for controlling processor 405 to execute the operations on behalf of CMS 110. For example, under control of program module 415, processor 405 performs the operations of CMS 110 described in methods 200 and 300.

Although in system 100, tag generating system 105 is depicted as being separate from CMS 110, tag generating system 105 could be integrated into CMS 110. As such, program module 415 could include instructions to control processor 405 to perform operations of tag generating system 105. Additionally, in the description of system 100, above, there are mentioned various servers, such as an image recognition server and a geolocation recognition server. These servers could also be integrated into CMS 110, and as such, program module 415 could include instructions to control processor 405 to perform operations of these servers.

While program module 415 is indicated as already loaded into memory 410, it may be configured on a storage medium 420 for subsequent loading into memory 410. Storage medium 420 is a tangible computer-readable storage medium and can be any conventional storage medium that stores program module 415 thereon in tangible form. Examples of storage medium 420 include a compact disk, a magnetic tape, a read only memory, an optical storage media, a hard drive or a memory unit consisting of multiple parallel hard drives, and a universal serial bus (USB) flash drive. Alternatively, storage medium 420 can be a random access memory, or other type of electronic storage, located on a remote storage system and coupled to CMS 110 via the Internet 145.

Below, we are providing several examples of the utilization of system 100.

### Example

### Magazine Article

Let's say you're reading a magazine on a bus. The bus arrives at your stop, and you want to read an article when you get to your next location, simply scan a tag on the article with your phone and a mobile application allows you store the article from the magazine to your phone so you have it with you no matter where you are. Or say you read an article in a printed magazine in which you think your friends on a social networking site would be interested. Without system 100, you would have to search through the Internet to see if the article is available online, copy and paste the URL then open a social networking application to share it. Instead, using system 100 you simply scan the tag with your phone and press the share button. The link is automatically published to all your friends where they can read it on their phone, computer or tablet.

### Example

### Newspaper Publisher

Imagine you are a local newspaper publisher creating hundreds of articles a day for your print publication. Without using system 100, creating custom web pages for every article that could be shared online would be a very labor intensive job. With system 100 you can simply copy and paste the article text into the CMS system and download the tag to be put next to each article. Every article is now scannable by your readers with the ability to share the article to their friends, expanding your circulation exponentially and allowing you to sell extra advertising space inside the web service interface.

Without system 100, traditional QR codes and NFC/RDIF delivery platforms inherently are (1) stagnant to the publisher, not allowing live administration with (2) inconsistent user experiences driving to unpredictable destinations involving (3) action limited, being tied to a single outbound URL. With system 100, actions are always associated with the digital version of print content rather than making the publisher or the user perform tasks manually.

### Example

### Pharmaceutical Product

Many functions can be attached to different types of content 117, such as for a pharmaceutical product in a bottle having a tag 120 that, when scanned, provides user 160 with usage information, and with function(s) 118 to (a) read instructions aloud for a user 160 who cannot read small type, or (b) translate the instructions into user 160's native language.

### Examples of Additional Content

Author videos and audio notes when reading a book.

Live stock market information related to stories about financial issues.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

What is claimed is:

1. A method comprising:
receiving digital content;
providing an interface that includes a template through which a user may enable a function from a plurality functions;
receiving a communication that indicates an enabled function from said plurality of functions;
storing said digital content and said enabled function, as data in a database; and
transmitting a link to said data.

2. A method comprising:
receiving a request for data, wherein said data includes digital content and a function;
transmitting said data;
receiving a request to execute said function; and
executing said function.

3. A method comprising:
(a) in an exchange of electronic communications with a computer:
receiving digital content;
providing an interface that includes a template through which a first user may enable a function from a plurality functions;
receiving a communication that indicates an enabled function from said plurality of functions;
storing said digital content and said enabled function, as data in a database; and
transmitting a link to said data, wherein said link is associated with a tag; and
(b) in an exchange of communications with a device that has captured said tag:
receiving said link;
retrieving said digital content and said enabled function from said database;
transmitting said digital content;
providing an interface for a second user to select said enabled function;
receiving a request to execute said enabled function; and
executing said enabled function.

4. A system comprising:
a processor; and
a memory that contains instructions that, when read by said processor, cause said processor to:
receive digital content;
provide an interface that includes a template through which a user may enable a function from a plurality functions;
receive a communication that indicates an enabled function from said plurality of functions;
store said digital content and said enabled function, as data in a database; and
transmit a link to said data.

5. A system comprising:
a processor; and
a memory that contains instructions that, when read by said processor, cause said processor to:
receive a request for data, wherein said data includes digital content and a function;
transmitting said data;
receive a request to execute said function; and
execute said function.

6. A system comprising:
a processor; and
a memory that contains instructions that, when read by said processor, cause said processor to:
(a) in an exchange of electronic communications with a computer:
receive digital content;
provide an interface that includes a template through which a first user may enable a function from a plurality functions;
receive a communication that indicates an enabled function from said plurality of functions;
store said digital content and said enabled function, as data in a database; and
transmit a link to said data, wherein said link is associated with a tag; and
(b) in an exchange of communications with a device that has captured said tag:
receive said link;
retrieve said digital content and said enabled function from said database;
transmit said digital content;
provide an interface for a second user to select said enabled function;
receive a request to execute said enabled function; and
execute said enabled function.

7. A storage medium that is tangible and computer-readable, comprising instructions that when read by a processor cause said processor to:
receive digital content;
provide an interface that includes a template through which a user may enable a function from a plurality functions;
receive a communication that indicates an enabled function from said plurality of functions;
store said digital content and said enabled function, as data in a database; and
transmit a link to said data.

8. A storage medium that is tangible and computer-readable, comprising instructions that when read by a processor cause said processor to:
receive a request for data, wherein said data includes digital content and a function;
transmitting said data;
receive a request to execute said function; and
execute said function.

9. A storage medium that is tangible and computer-readable, comprising instructions that when read by a processor cause said processor to:
(a) in an exchange of electronic communications with a computer:
receive digital content;
provide an interface that includes a template through which a first user may enable a function from a plurality functions;
receive a communication that indicates an enabled function from said plurality of functions;
store said digital content and said enabled function, as data in a database; and
transmit a link to said data, wherein said link is associated with a tag; and
(b) in an exchange of communications with a device that has captured said tag:
receive said link;
retrieve said digital content and said enabled function from said database;
transmit said digital content;
provide an interface for a second user to select said enabled function;
receive a request to execute said enabled function; and
execute said enabled function.
